(19) United States
(12) Patent Application Publication
(10) Pub. No.: US 2004/0093230 A1
(43) Pub. Date: May 13, 2004

(54) Automated customer response system

(76) Inventor: Greg Deogard, Westchester, CA (US)

Correspondence Address: MICHAEL A. SHIPPEY, PH. D., 4848 LAKEVIEW AVENUE, SUITE B, YORBA LINDA, CA, 92886, US

(21) Appl. No.: 10/294,311

(22) Filed: Nov. 13, 2002

(51) Int. Cl. G06F 17/60

(52) U.S. Cl. 705/1; 705/11

(57) ABSTRACT

ACRS is an interactive network-based process tool designed to collect, communicate, and address customer inquiries, comments, and problems regarding an organization, its products, services, or any other offerings. The ACRS process identifies the customer's needs and issues and establishes a consistent and direct link between the customer and the organization for purposes of providing an appropriate response to the customer immediately, scheduling follow-up actions, and compiling performance results.

### BACKGROUND OF THE INVENTION

1. Field of the Invention

The present invention relates generally to a network-based automated customer response system and method, and more particularly to a process for collecting, assimilating, and responding to customer communications of any kind, including inquiries, complaints, problems, comments, and compliments. The invention finds particular application in the automated handling of customer information through a network-based system that accepts it, assigns it for response, provides for scheduled follow-ups, and compiles performance results, and it will be described with particular reference thereto. However, it will be recognized that the present invention finds application in other customer communication environments.

2. Description of Related Art

Electronic systems for receiving customer communications using a network, web-based service consist currently of response forms with fields on them that a customer can complete with required and optional information and comments. The customer then sends the data contained in the fields to the organization by means of an email and the information is saved in a database. This send function can be activated in any number of ways, such as by an electronic button on the form activating a script or other software programming for automatically saving the information into the database. Some but not all of these systems provide security encryption for the message sent. This type of system does not interact with the customer, it relies on human review and analysis, classification, and handling of the communication, and it requires a response time to the customer of several hours, days, or even weeks, if there is a response mechanism at all.

Against the background of known technology, the applicants have developed a new process and method for the collection and handling of consumer and customer communications and information. This new process and method reduces the time required to collect, assess, and classify communications and information received from a customer and allows for a more accurate and immediate response to specific problems, comments, complaints, inquiries, or other communications. In addition, it sets up automatic time triggers to schedule and implement follow-up actions. Finally, it provides a means of evaluating the process by automated reports of performance results and can incorporate new information into the account review process.

A search of current and prior art does not disclose any patents that read directly to any of the claims of this invention.

### BRIEF SUMMARY OF THE INVENTION

The present innovative process begins when a customer inputs data into the ACRS indicating that he or she has a question, inquiry, comment, problem, complaint, or other information. The input form is specially designed for ease of use and for specific and consistent data collection that can be used in the account review process to handle the customer's information in the most efficient and constant manner, such that the same problem, inquiry, comment, or other information collected from different customers can be handled with the same response and application of the same standards and guidelines. This method of data collection will enhance customer satisfaction with the method, as well as with the organization that has implement the ACRS system, and in addition it will return reliable and consistent results about customer needs and opinions regarding the products, services, and other offerings and about the reputation, policies, and effectiveness of the organization itself.

The data is collected using the latest technology methods available for collection of data over a network, web-based system, and the customer is then asked to input additional information, including contact data (such as name, email address, location) and information about the problem, inquiry, or other comment being made. When the customer submits this information, a ticket is issued and the ACRS issues a ticket and routes the information for immediate response. This initial response process is specially designed to give instant communication to the customer and to assess the customer's information at electronic speed so that it can be quickly routed for handling.

If the customer submits a comment only, the information is held for reporting purposes and the ticket is automatically closed. If the customer submits a problem or complaint, ACRS analyzes all of the information submitted to assign a problem solver or group of problem solvers to the ticket. The customer is automatically notified by email confirming receipt of the customer's information and giving the assignment information, and at the same time email notification is sent to the problem solver with all information provided by the customer. The ACRS method is designed to set up an efficient and consistent structure within the organization for the handling and compiling of customer information and for creating a direct link of communication with the customer. In this way, customer information can be more easily assessed, improvements in products, services, and customer service can be implemented based on reliable reports generated through ACRS, and customer satisfaction is likely to rise, enhancing the good will and reputation of the organization that has implemented the ACRS system.

After email notification are sent to the customer and the problem solver, the ACRS system updates itself with the time and date of the email sent to the problem solver and starts a timer mechanism to send reminders to the problem solver to resolve the problem or otherwise follow-up with the customer. On resolving the problem, the problem solver updates the customer's ticket in the ACRS system. The ACRS system then sends an email to the customer asking if the problem has been resolved to the customer's satisfaction. The customer can answer “yes” or “no” to this email. If the customer's answer is “yes,” the ACRS system updates the ticket to a closed status. If the customer's answer is “no” the ACRS system reopens the ticket and updates it with any new information from the customer, sends another email to the problem solver, starts the timer again, and the response cycle starts over. The ACRS system has been carefully constructed to keep direct and timely contact with the customer so that the customer's issues can be addressed promptly and accurately. It further allows the organization to evaluate its own performance for purposes of improving customer relations and its own products and services to evaluate accurately the stated needs of its customers and to incorporate and develop that meet those specific needs.

### BRIEF DESCRIPTION OF THE DRAWINGS AND TABLES

The invention will now be described, by way of example only, with references to the accompanying drawings, as follows:

FIG. 1 is a flow chart describing and showing an overview of the sequence of steps of the ACRS process.

FIG. 2 is an example of an email message requesting a customer's opinion his or her contact with the organization that has implemented the ACRS system.

FIG. 3 illustrates part of a web page form generated by the ACRS system for the initial collection of customer information.

FIG. 4 is an example screen shot of the database fields for the customer tickets used to collect and compile the customer data.

Table 1 lists the preferable software components of the ACRS system.

Table 2 lists the preferable computer server components for operation of the ACRS system's software.

### DETAILED DESCRIPTION OF THE INVENTION

The present invention is a network, web-based process for automating collection and evaluation of customer information and development of a response to the customer's communication that meets the needs of the customer to his or her satisfaction.

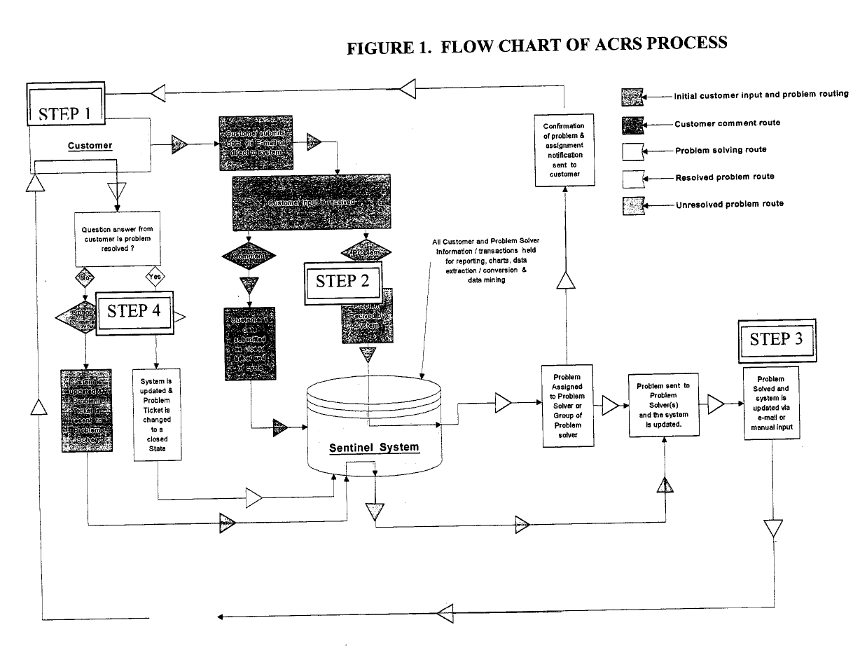

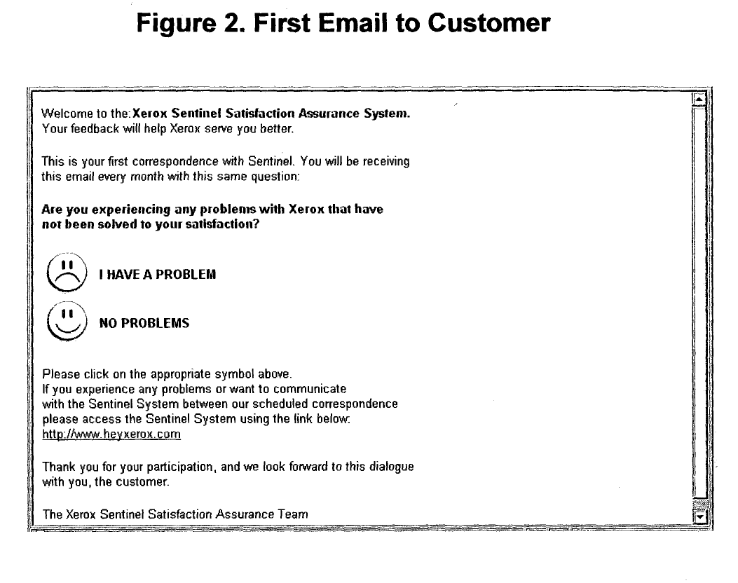

The flow chart shown in FIG. 1 depicts the sequence of the ACRS system. At STEP 1, the Customer submits information to the ACRS system by means of an electronic message. An organization that has implemented the ACRS system may solicit this information by means of an email message, such as the one illustrated in FIG. 2, from a customer who has contacted the organization, or the customer may initiate the contact. In either event, the sequence that commences is controlled by the ACRS software, which is comprised of certain standard and modifiable components. The preferred software components are listed in TABLE 2, but these components are not limited to those listed. The ACRS system software allows for modifications to suit the needs of the particular organization implementing the ACRS system.

The ACRS system may be adapted to receive various formats of electronic messages as technology dictates. Currently, there are three preferable means used for sending electronic messages into the ACRS system, specifically (1) a text email that is sent through the Internet and that has within it a special link that will automatically log the customer into the ACRS system, at which point the ACRS system will display a page asking the customer if he or she has a problem, inquiry, or just a comment; (2) an email using HTML format that is sent to the customer asking if he or she has a problem, inquiry, or just a comment; or (3) a direct link into the system through a WAN/LAN network system. When this data is received by the ACRS system, the system will ask for additional information from the customer for purposes of contacting and locating the customer, including the customer's name, address, location, email address, and the specific problem or comment.

In STEP 2 of FIG. 1, the customer's data is received by the ACRS system database that has been implemented by the organization using the ACRS system. This database will be located on equipment maintained or otherwise under the control of the organization that has implemented the ACRS system. The preferable equipment would be a computer server, such as one that has the specifications listed in TABLE 2, but the equipment used is not limited to such a server. The ACRS system is adaptable to the technologies available to the organization that uses it.

On receiving the customer's data, the ACRS system creates a ticket for the customer and analyzes the data automatically so as to continue to process the ticket. If the customer is submitting a comment only, the customer's information is saved into the ACRS database and the ACRS system marks the ticket as closed. The ACRS system then retains the customer's information for purposes of compiling reports and charts and data mining, and it returns a confirmation email to the customer. If the customer has indicated that there is a problem, the ACRS system will create a ticket for the customer and will automatically assign a problem solver or group of problem solvers the ticket. This assignment is made based on scripts developed to analyze the specific data received from the client, including information about the customer's location, and the products, services, or projects that is the subject of the customer's inquiry or problem. In addition, the ACRS system will take into account the number of tickets outstanding for the problem solvers and will designate a problem solver based on a round robin approach or the lowest number of tickets. At this point, which is STEP 3 in FIG. 1, the ACRS sends an automated message by email to the customer confirming receipt of the customer's data and notifying the customer of the assigned ticket number and problem solver.

As STEP 3 continues, the ACRS system immediately sends a second automated message by email to the problem solver. This message contains all of the data provided when the ticket was completed by the customer, plus the time and date of receipt of the customer's data. The ACRS system also updates the customer's ticket held in its own database for the time and date the email message was sent to the problem solver and it starts a timer for purposes of following up on the message. The timer can be set to any number of hours, days, or weeks by the organization that has implemented the ACRS system. When the timer reaches the set time and date, the ACRS system will send an automatic message to the problem solver to remind him or her to resolve the problem or to have the ACRS system send the ticket to the next level of response and resolution. This scheduled reminder system will continue to repeat automatically until, at the end of STEP 3, a problem solver has resolved the customer's problem and has updated the ACRS system by sending an email message or by logging into the ACRS system and manually inputting data indicating that the situation has been resolved.

When the ACRS system receives the problem solver's update of the ticket stating that the situation has been resolved, STEP 4 of FIG. 1 commences. At this Step, the ACRS system follows up with the customer by sending an automated text or HTML email message. If the customer receives a text email, the email will contain a special link that, when activated, will display a page in the ACRS system asking the customer if the problem has been resolved to the customer's satisfaction. The customer will have an option to reply “yes” or “no.” Inside the link, it will also have a log-in date, name, password, project, company, ticket number, and other information previously supplied by the customer. If the customer receives an email in HTML format, the email will ask the customer if the problem has been resolved to the customer's satisfaction. The customer will have an option to reply “yes” or “no.” Behind the HTML code, a script will contain the log-in date, name, password, project, company, ticket number, and other information previously supplied by the customer.

If the customer answers the text or HTML email message with the “yes” response, the ACRS system updates the customer's tickets, changes it to a closed state, and retains the data for reports and charts on performance evaluation. At this point, the process for this particular customer ticket ends. If the customer answers with the “no” response, the ACRS system updates the customer's comments, time, and date fields for the customer's tickets and automatically sends another email message to the problem solver alerting him or her that the problem has not been resolved. Included in this email message is all of the customer's information from the ticket, plus any additional updated information from the customer and the dates of opening and reopening the ticket. The ACRS cycle then returns to STEP 3 and starts the resolution process again. STEP 3 and STEP 4 can continue to recycle as needed.

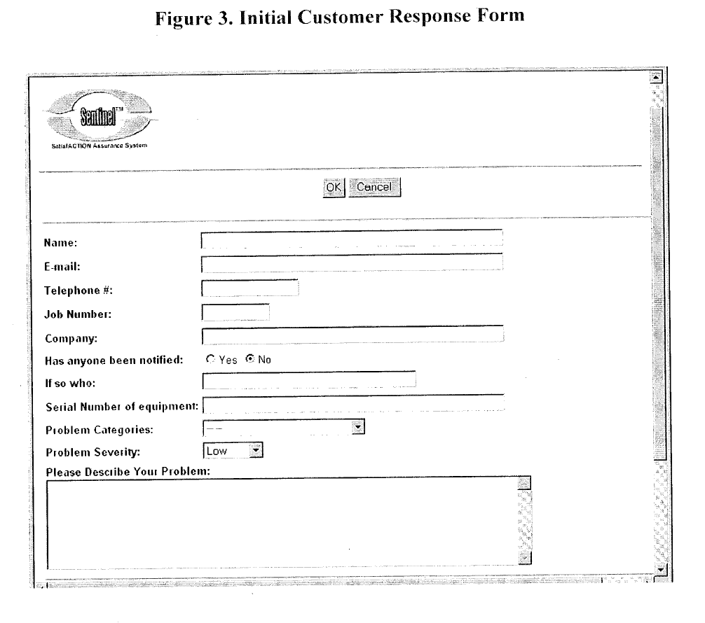

FIG. 2 illustrates the email and data collection form that is sent to a customer who has had contact with an organization using the ACRS system. Any particular company can modify the content of this email to its own preferences, except that the “yes” and “no” option buttons remain constant. If the customer clicks on the “yes” button (indicating a desire to communicate to the company), the customer will linked to the web page illustrated in FIG. 3.

FIG. 3 is part of a sample web page form for the electronic collection of customer data. A customer that has received an email, similar to the message shown in FIG. 2, would be linked to this web page form for purposes of communicating to the company using the ACRS system. The form contains fields corresponding to the fields that are in the company's database on its server. When a customer completes the fields on the web page form and submits the data to the company by clicking a submit button, the data will be transmitted to the company's ACRS system, starting the ACRS process as described in FIG. 1.

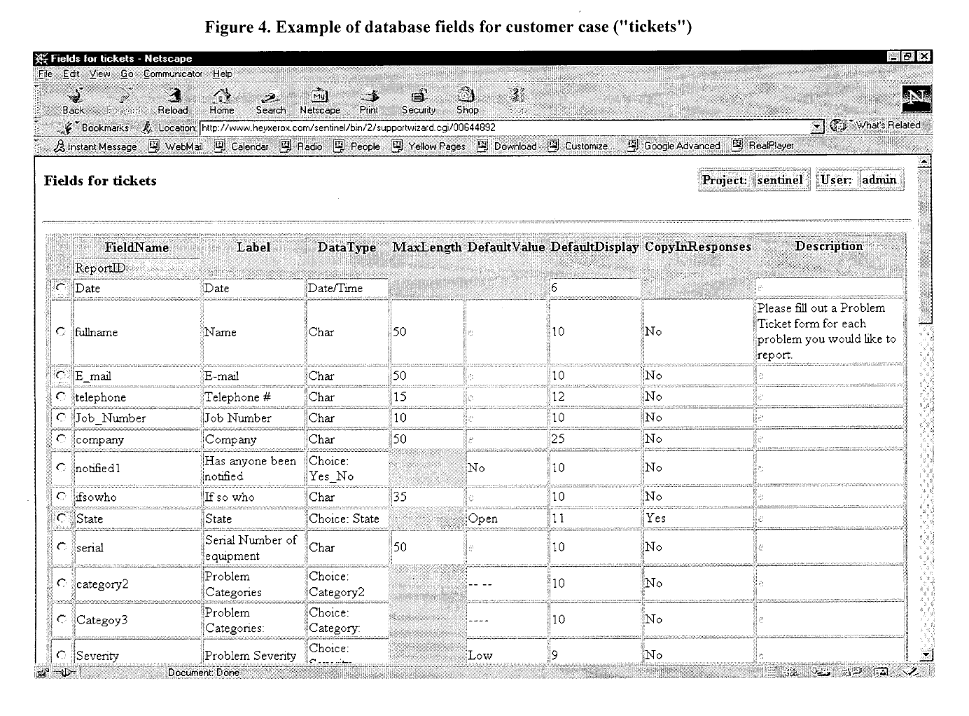

FIG. 4 illustrates some of the database fields for a customer ticket saved in the ACRS system. Information from the customer and generated automatically by the ACRS system is saved into the fields of the database at various stages of the ACRS process described and illustrated for FIG. 1. These fields are subject to modification to account for variations in the customer information that is most relevant to the products, services, and issues of any particular organization. This Figure serves, therefore, as a sample of the fields that a single customer's ticket would contain. For this particular organization, it is assumed that a customer complaint or comment is related to particular equipment, and therefore the database collects the serial number of the equipment on the tenth line of the illustration in this Figure.

It will be apparent to the skilled reader that this description of the present invention, both in text and as shown in the accompanying drawings, should be interpreted as illustrative and not in a limiting sense to the invention herein contemplated.

### Computer Program Listing

A listing of the computer software to Sentinel, the heart of the ACRS system, is supplied as an appendix on CD-ROM.

TABLE 1
PREFERRED SOFTWARE COMPONENTS OF THE ACRS SYSTEM

Forms and Charts: Text and Data Fields
Data reports
Email systems for sending and keeping a count of answered and
unanswered emails
Tickets page
Problem solver work pages
Email page for problems and no problems
Under no problem comments section
Location line
Workflow page
All fields keyable
Data Pages for Searching Reports and Charts
Inside help files for problem solvers and customers
Help for fields on each page
Page for field creation and modification
Pages of Systems
HTML email
Welcome page
Customer ticket page (more than one)
Customer no problem comment page
Thank you page
Email to Problem Solver and customer
Problem Solver log-in page
Problem Solver main page
Problem Solver ticket page
Problem Solver report page
Problem Solver chart page
Problem Solver update of ticket page
Problem Solver create new ticket page
Problem Solver exit page
Administrative Pages
Admin log-in page
Admin main page
Admin ticket page
Admin report page
Admin chart page
Admin update of ticket page
Admin create of new ticket page
Admin exit page
Admin field custom page
Admin workflow page
Admin escalation page
Admin import export page for the whole project and database
Admin setup page for graphics
Admin page for creation of new projects

TABLE 2
PREFERRED HARDWARE COMPONENTS OF THE ACRS
SYSTEM

| Quantity | Description & Manufacturing |
|---|---|
| 3 | CPQ DL380 G2 7/1266 PKG CLUSTER |
| 6 | SIMPLE 2 GB CPQ PROLIANT DL380 G2 |
| 18 | CPQ REDUN HOT PLUG P/S DL380 G2 |
| 18 | CPQ HOT PLUG REDUN FAN DL380 G2 |
| 12 | CPQ 72.8 GB PLUG ULTRA3 1” 10 K |
| 3 | CPQ SVC PK 24 × 7 × 4 CL380 CL 1850 |
| 1 | CPQ MSL5026SL 2SDLT 110/220 LVD RM |
| 1 | CPQ SVC PK 24 × 7 × 4 DLT/SDLT 1-2 DRIVE |
| 78 | QUANTUM SUPER DLT I 110/220 GB |
| 48 | CPQ 18.2 GB PLUG ULTRA3 1” 10 K |
| 12 | CPQ SMART ARRAY 431 CONTROLLER |
| 1 | CISCO PIX 525 UR S/W BUNDLE |
| 1 | CISCO SMARTNET 24 × 7 × 4 CAT14 |
| 2 | FOUNDRY SERVERIRONXL 16PT 10/100 |
| 3 | CPQ SMART ARRAY CLUSTER CONTROLLER |
| 12 | CPQ PROLIANT DL380 G2 7/1266 256 MB |
| 13 | SIMPLE 1 GB CPQ PROLIANT DL380 G2 |
| 12 | CPQ DL380 G2 7/1266 PROC OPT KIT |
| 12 | CPQ SVC PK 24 × 7 × 4 1850 ML370 DL380 |
| 9 | CPQ EVO300s with monitor |

What is claimed is:

1. An Internet compatible, computer network-based process for collecting, assimilating, and responding to customer inquiries, problems, and complaints, said process comprising a means to accept customer information; a means to create a numbered case with said information; a means to assign said case to the appropriate problem-solving personnel; an means for notifying said personnel for follow-up actions at specific future times; a means for providing replies to the customer; and a means for providing performance results.

2. A process as described in claim 1, further comprising a central database and program for data storage, data extraction and conversion, charting and reporting.

3. A process as described in claim 1, further comprising a link to the Internet for accepting customer e-mail into said process.

4. A process as described in claim 1, further comprising a link for customers to connect directly into said process via a Wide Area Network (WAN), Local Area Network (LAN), or the like.

5. A process as described in claim 1, further comprising automated means for generation of said case containing said customer information.

6. A process as described in claim 1, further comprising automated means for assignment of said case to personnel.

7. A process as described in claim 1, further comprising automated means for notification of said personnel for said follow-up actions.

8. A process as described in claim 1, further comprising automated means for accepting customer feedback after one iteration of said process, and closing said case if the customer indicates satisfaction, or alternatively initiating the process again if the customer indicates dissatisfaction.

9. A process as described in claim 1, further comprising the computer software as provided in the listing provided on CD.

10. A process for responding to customer inquiries, problems, and complaints, as portrayed in Drawing 1, comprising a means to accept customer information, a means to create a numbered case with said information; a means to assign said case to the appropriate problem-solving personnel; an automated means for notifying said personnel for follow-up actions at specific future times; a means for providing replies to the customer; and a means for providing automatic performance results.

11. A process as described in claim 10, further comprising the computer software as provided in the listing provided on CD.
